(19) United States
(12) Patent Application Publication
(10) Pub. No.: US 2005/0097930 A1
(43) Pub. Date: May 12, 2005

(54) Anti-theft method and system for portable electronic devices

(75) Inventors: Jason Eric Moore, Austin, TX (US); Rafael Graniello Cabezas, Austin, TX (US); Elizabeth Silvia, Austin, TX (US); Liliana Orozco, (US)

Correspondence Address: Darcell Walker, Suite 250, 9301 Southwest Freeway, Houston, TX, 77074, US

(73) Assignee: International Business Machines Corporation, Armonk, NY (US)

(21) Appl. No.: 10/703,022

(22) Filed: Nov. 6, 2003

(51) Int. Cl. E05B 69/00; E05B 73/00

(52) U.S. Cl. 70/58

(57) ABSTRACT

The present invention provides an anti-theft security method and system for portable electronic devices. This invention shifts the locking step from the external security device that engages the electronic device to the actual electronic device. This system comprises a portable electronic device having a opening therein for the purpose of engaging a securing device that will security the electronic device to some stationary object such as a desk. The securing device is typically a cable. This cable has one end that engages the electronic device through the opening the electronic device. Once engaged, a shutter activated by the electronic device reconfigures the opening in the electronic device to prevent the disengagement of the cable from the electronic device.

### FIELD OF THE INVENTION

The present invention relates to an anti-theft system for portable electronic devices and more particularly to an anti-theft system, which is internally activated by the actual electronic device being secured.

### BACKGROUND OF THE INVENTION

In the past several years the use of portable computers and other high-priced, portable electronic devices have increased dramatically. Computers have evolved rather rapidly from large, expensive machines usable only by a few, to relatively small, portable machines, which are usable by many. In particular, the development of desktop computers with significant processing power has made computers available to the general population. It is now common for college and even high school students to have their own computer, and desktop computers are in widespread use as word processors and workstations in almost all forms of business. Many computers and other electronic devices are relatively small and easily transportable. An undesirable side effect of the proliferation of smaller and portable electronic devices is that these devices are primary targets for thieves. Theft of such computers and other devices is a significant problem.

While the size of these devices promotes efficiency due to their ease of transportation, the portable nature of these devices also renders them susceptible to theft. Computers and other portable electronic devices of all types are subject to theft. Protecting computers is essential due to the expense associated with replacing them. Equally important, if not more important, is the need to protect any confidential information stored on the computer. A study conducted by Rand Corporation in March of 1999 claims that U.S. corporations lose more than $4 billion a year in electronic thefts. Personal computers, particularly laptop computers, make up a considerable portion of this stolen electronic equipment. Accordingly, there is a corresponding need to enhance the theft protection measures for these devices through adaptable locking means.

Users of these portable devices have relied primarily on secondary security measures, such as maintaining the device in a locked drawer when not in use, or attaching a locking device to the handle of the computer for securing the computer during periods of non-use. These security measures, however, have proven to be highly ineffective due to the ease with which they are overcome and the inconvenience of these measures to the user who does not consistently implement them to protect the device. A shortcoming of utilizing a chain or some other standard device around the handle of a portable computer carrier lies in the fact that the handle may be easily broken away with relatively little effort, thereby permitting the theft of the computer or other protected apparatus. Locking the computer in a storage area such as a desk drawer or a file cabinet, when not in use, represents an alternative solution to the potential threat of theft. However, such security measures lead to decreased efficiency regarding the use of the computer due to the expenditure of additional time and effort in securing the computer in the storage area and then retrieving it prior to use. In addition, these cabinets are not available in many locations, such as airport terminals where there is frequent theft of these devices.

Accordingly, it has been proposed that a lock, which may be inserted into a standardized and dedicated locking aperture within the body of a portable computer or other device to be secured, would overcome the prior disadvantages and problems. Such a lock should have high security attributes which will preclude a thief from easily overcoming the lock by means of either picking or forced disengagement of the lock due to withdrawal of the locking member.

Presently, some personal computers include a rectangular-shaped lock hole that allows a theft deterrent device to be attached. U.S. Patent Application Publication 2003/0029208 describes a laptop computer with such a rectangular shaped lock opening. The lock hole provided in many brands of computers is configured to receive a standardized lock such as a Kensington-type lock. Kensington-type locks have a retention member including a generally rectangular-shaped cross bar for engaging the lock hole of the computer to secure the theft deterrent device to the computer. One prior art theft deterrent device includes a lock for being attached to the lock hole and a cable attached to the lock for being secured to a remote article that is immovable or difficult to move.

U.S. Pat. No. 6,389,853 describes an apparatus for deterring theft of an electronic device, includes a lock having a housing and a retention member movably mounted in the housing for being moved between a locked position and an unlocked position. An elongated retaining member has a first end connected to the lock, and a second end connected to an anchoring member. A plurality of contacts are attached to the lock. A first one of the contacts is electrically isolated from a second one of the contacts. A continuity detection element is attached to the retaining member for detecting a discontinuity between the first and the second ends of the retaining member. The continuity detection element is electrically connected to the first and the second contacts.

U.S. Pat. No. 6,463,770 describes a lock for a computer has a housing, a core pivotally mounted to the housing, a latch formed on and extending out of the core, a rod coupled to the core. The rod has a flange end and a pair of pins extending from the flange end. A spring is disposed around the rod to provide a resilience to the pins, and a cable is pivotally connected to the housing. A case of the computer has a latch chamber and an entrance communicates with the latch chamber to allow the latch and the pin to enter the latch chamber through the entrance.

U.S. Patent Application Publication 2003/0029208 describes an invention that includes an apparatus for attaching to a first wall defining a security aperture. The apparatus includes a housing; a locking flange, extending from the housing, having a first orientation relative to the security aperture for retention into the security aperture and a second orientation relative to the security aperture for removal from the security aperture, the locking flange transformable from the first orientation to the second orientation; and a locking member, coupled to the housing and cooperative with the locking flange, for engaging an edge of the first wall outside of the security aperture and inhibiting transformation of the locking flange from the first orientation to the second orientation.

The attachment of a conventional theft deterrent device does well at preventing theft by the ‘opportunist-type’ of thief. Most of these types of thieves are not equipped with the required tools to readily defeat a conventional theft deterrent device. However, a more determined and prepared thief can easily cut the cable of a conventional theft deterrent device, allowing the computer to be removed from the premises.

The implementations of the current security devices to secure portable electronic devices involve external engagement or attachment of the security device to the electronic device. The actual electronic device has a generally passive role in the security of the device. There remains a need for an anti-theft security system for portable electronic devices in which the securing process is activated through the electronic device.

### SUMMARY OF THE INVENTION

It is an objective of the present invention to provide a locking mechanism for portable electronic devices.

It is a second objective of the present invention to provide a locking mechanism for a portable electronic device that can be activated by the electronic device.

It is a third objective of the present invention to provide shutter mechanism in the electronic device that can alter the configuration of a security opening in the electronic device.

The present invention provides an anti-theft security system for portable electronic devices. This invention shifts the locking step from the external security device that engages the electronic device to the actual electronic device. This system comprises a portable electronic device having a opening therein for the purpose of engaging a securing device that will security the electronic device to some stationary object such as a desk. The securing device is typically a cable. This cable has one end that engages the electronic device through the opening the electronic device. Once engaged, the opening in the electronic device is reconfigured to prevent the disengagement of the cable from the electronic device.

The reconfiguration of the opening is done by electronic instruction within the device. The device user can send the command/instruction for the electronic device to reconfigure. As part of the reconfigure process, the user may be required to submit a password to verify that the user has the authority to change the current security configuration of the device.

In operation, the securing device is configured to a shape that matches the shape of the opening in the electronic device. The matching end of the securing device (usually a cable) is then inserted through the opening in the electronic device. At this point, the user can issue a command to the electronic device to reconfigure the shape of the opening in the device and thereby locking the securing device to the electronic device. As mentioned, the other end of the securing device (cable) can be attached to a stationary object such as a desk. When the user desires to unlock the electronic device, the user issue another command that will cause the electronic device to reconfigure the shape of the opening in the device to match that engaging end of the securing device. Once the end of the securing device matches the opening, the securing device can be withdrawn from the electronic device and thereby unlocking the electronics device.

### DESCRIPTION OF THE DRAWINGS

FIG. 1 is a view of a laptop computer as an example of a portable electronic device.

FIG. 2 is a view of an opening in the electronic through which one can insert a securing cable.

FIG. 3 is a cross-view of the engaging end of a cable used to secure portable electronic devices, the view being of the cable in an open or unlocked position.

FIG. 4 is a cross-view of the engaging end of a cable used to secure portable electronic devices, the view being of the cable in a closed, secured or locked position.

FIG. 5 is a view of a laptop computer having a modified opening for the electronic device in accordance with the present invention.

FIG. 6 is a view of a shutter mechanism to be used with the modified opening as described in FIG. 5.

FIG. 7a illustrates the front view of the shutter in the open position.

FIG. 7b illustrates the side view of the shutter in the open position.

FIG. 8a illustrates the front view of the shutter in the closed/locked position.

FIG. 8b illustrates the side view of the shutter in the closed/locked position.

FIG. 9 is a flow diagram of the steps to activate the security system of the present invention.

### DETAILED DESCRIPTION OF THE INVENTION

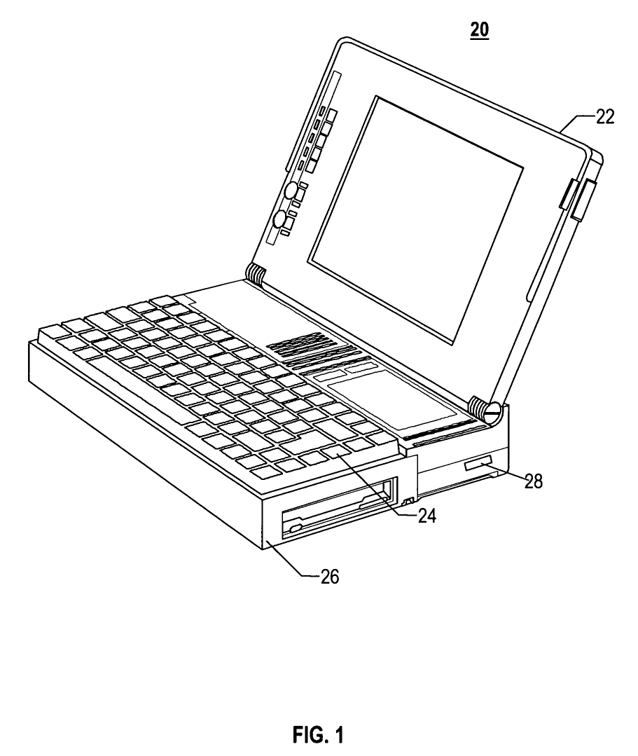

Referring to FIG. 1, shown is a laptop computer 20, which is a typical portable electronic device to which the present invention can apply. This device will be used for the purpose of describing an implementation of the present invention. This computer has a hinged member 22 that has an opened configuration (as shown) permitting access to the keys and other operational interface elements 24 of device 20, and a closed configuration (not shown) in which hinged member 22 overlies operational interface elements 24 to inhibit access. Device 20 has a side wall 26 that defines a security opening 28. Preferably, security aperture conforms to Kensington security standard.

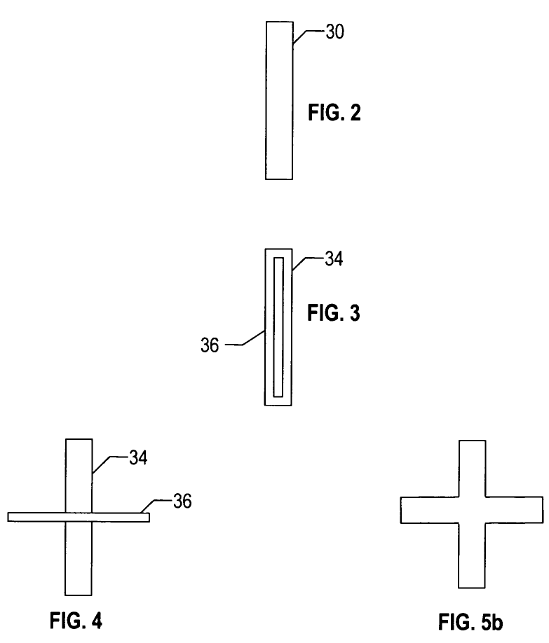

FIG. 2 illustrates the general shape of a security opening. As shown, this opening is a rectangular slit 30. This opening has a shape that provides for insertion and engagement of a security cable. The opening can be vertical as shown or it can be horizontal as previously indicated in U.S. Patent Application Publication 2003/0029208.

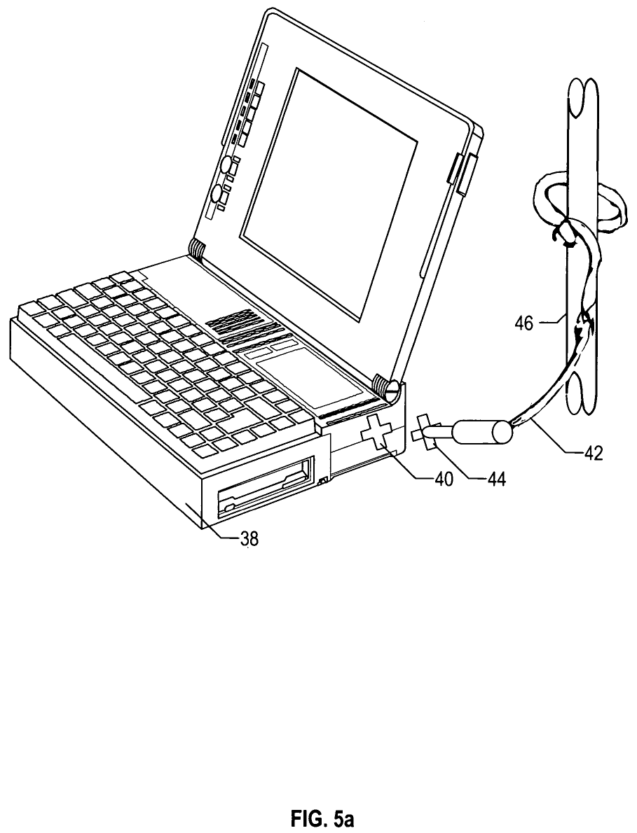

FIG. 3 illustrates the end of the security cable that will engage the electronic device through the security opening 30. The cable end 44 (see FIG. 5a) comprises two parallel bars 34 and 36. Bar 34 can be permanently fixed in a vertical position. Bar 36 can be capable of rotating between vertical and horizontal positions. A key can be inserted into the cable end to rotate bar 36 from a vertical to a horizontal position and also back to a vertical position. Conventional cable ends require a key to rotate the single bar between vertical and horizontal positions. As shown in FIG. 4, in the locked position, the bar 36 can rotate to a horizontal positional position. When bar 36 is rotated, the two bars form a cross-shaped configuration inside the computer slit. Therefore, because one bar has an orientation opposite that of the slit in the electronic device, the cable head does not match the straight slit security opening of the electronic device. As a result, the cable cannot be withdrawn or disengaged from the computer. Since the cable is secured to some stationary object such as desk, the electronic device becomes secured to the desk.

FIG. 5a is a view of a laptop computer (electronic device) having a modified opening in accordance with the present invention. As shown, FIG. 5a illustrates the attachment of the computer to a stationary device such as a desk leg 46. The cable 42 has a connector end 44 that will engage the computer 20 through the security opening 28. In this configuration, the opening 28 as shown in FIG. 5b is in the shape of a cross. This configuration matches the previously discussed securing end configuration 44 of the cable when that end is in the locked position. The matching configurations allow for the insertion of the cable end into the electronic device through this modified opening.

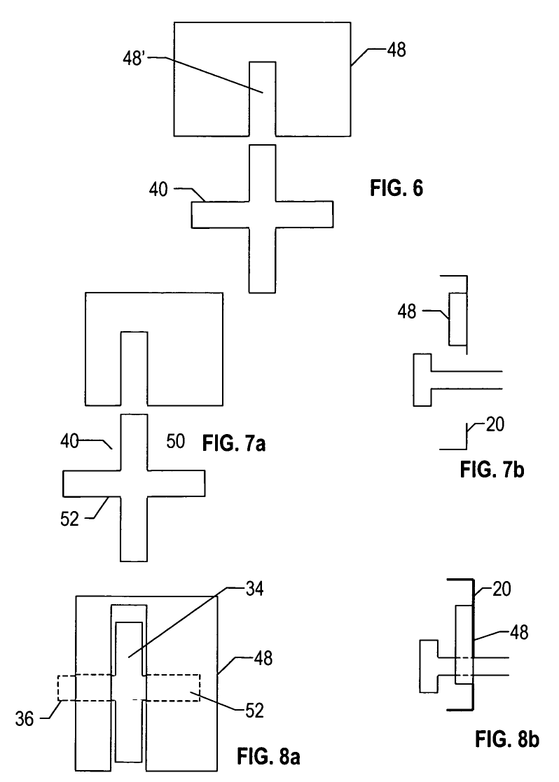

FIG. 6 shows the shutter 48 that can be moved into a position between the inserted end of the cable and the opening in the electronic device. The shutter has a flat square to rectangular shape. The shutter serves to close off the horizontal portion of the opening and prevent to the horizontal bar of the cable from passing the opening. As shown, the shutter 48 can be positioned above the security opening. Other shutter designs may close off the vertical portion of the design. The shutter has a recess portion 48′ that will provide for the clearance of the vertical bar 34 when the shutter is lowered to cover the security opening 28.

As shown in FIG. 7a, the security opening 28 in the computer comprises a vertical slit 50 and a horizontal slit 52. The cable 42 with the bars 34 and 36 in the locked position as shown in FIG. 4, is inserted into the device through the cross shaped opening. FIG. 7b shows the position of the shutter 48 in the up or open position inside the electronic device. As shown in this illustration, the shutter is positioned above the opening. When the shutter is in the down position or closed position, FIG. 8a, the shutter covers the horizontal slit 52. The resulting configuration is similar to the configuration in FIG. 2 in which, only the vertical slit remains uncovered. Because only the vertical slit is uncovered, the cable end having a cross shaped configuration in the locked position cannot pass through the solely vertical opening and be removed from the electronic device. FIG. 8b shows the side view of the shutter 48 in the down or closed position within the computer.

The configuration described and illustrated in FIGS. 6, 7a, 7b, 8a and 8b is one implementation of the present invention. Although not illustrated, as mentioned, the shutter in FIG. 6 could have the recess portion 48′ in a horizontal direction. In this configuration, the shutter would cover and block the vertical bar 34 when the shutter is in the closed position. Furthermore, as opposed to FIGS. 7b and 8b, the shutter could be positioned to one side of the opening 40. In this position, the shutter would move laterally to open and close the opening as desired to lock and unlock the electronic device.

The configuration of the bars 34 and 36 can be altered either before insertion of the end into the electronic device or after insertion into the electronic device. Since the opening 40 of the present invention has a cross-shape, the opening can receive either a straight configuration in which both bars are aligned in the same direction (parallel) or a cross-shaped configuration in which the bars are perpendicular to each other. The locking mechanism is the shutter inside the electronic device. As a result, the orientation at which the bars are inserted into the cross-shape opening is not important to the implementation of the present invention.

The particular shape of the opening 40 can vary from the cross-shape illustrated and discussed in this invention. The purpose of the opening is to facilitate the insertion of the cable end 44 into the electronic device and passed the point of the shutter path. As a result, the opening 40 and cable end 44 can have varied shapes. For example, the opening 40 could be round and the cable end could have the shape of a round disk. The shutter 48 can also have a different shape from the above-described rectangular shape. Regardless of the shutter shape, the shutter will still have a recess portion 48′ will provide a clearance to enable the shutter move in position such that the shutter is between the cable end 44 and the opening 40.

The actuating means to provide movement for the shutter between open and close positions can be any conventional mechanical means. One example of the actuating means that controls the movement of the shutter could be an electromechanical toggle switch that moves between two positions. Whenever the switch receives a signal, the switch would move or toggle to the other position. In the present invention, the user could send an internal signal to the toggle to cause the shutter to move in the down or close and locked position. Later, the user would send another signal to the switch. Because the switch is in the down or locked position, the toggle would move to the up position thereby causing the shutter to move to the up position and thereby raise the shutter to unlock the security cable from the electronic device. Other components of a computer such the remote disk drive have some mechanical functions. In addition, other electronic devices such as cameras have internal mechanical devices that move shutters between multiple positions. Therefore, the implementation of a mechanical means to facilitate movement of the shutter in the present invention should be readily achievable.

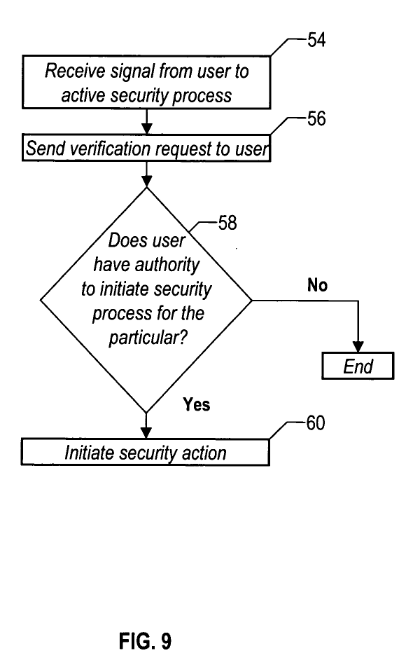

The system of the present invention also provides for a method that will enable a user to initiate the locking and unlocking of the security device to the electronic device through the actual electronic device. Referring to FIG. 9, a signal is received by the process in step 54. This signal initiates the unlocking/unlocking process. The user can generate this command via the keyboard or by clicking an icon from a popup menu or other menu. Once the process receives this signal, step 56 sends a user verification request to the user. The user will need to supply some information to verify the authority of the user to activate this security process. In many instances, this information would be a user ID and a user password. The user ID and password can be matched to the identity of the particular electronic device. A data storage location within the device can contain a list of user ID's and passwords of particular user(s) that can access for the device for the purpose of changing the security of the device in accordance with this invention. The authentication process can also have the user supply biometric data or smart data as a way to verify the identity of the user desiring to change the security status of the device. The method of the present invention can also periodically prompt the user change the password as part of good security procedure.

Step 58 will determine if there is a match between the user and the particular device. If the identified user has the authority to activate this process for the identified device, the initialization of the process will occur. Step 60 will send a signal to reverse the current position of the shutter. If the shutter is in the up and unlocked position, as shown in FIG. 7a, the shutter will come down and be in the closed position shown in FIG. 8a.

In some instances, the electronic device may lose power. If the device is in the locked position, the user can manually rotate the cross bar 36 of the cable end with a key as done in current locking systems. In this case, the rotation of bar 36 will cause the rotation of bars 34 and 36 to align with each other and the shutter recess 48′. If the user desires to lock the electronic device while the power is off and the device is in the locked position, the user can insert the cable key and manually rotate one bar such that a cross configuration is created that will secure the electronic device in a conventional manner. Whenever the electronic device regains power, a self-test can be performed to assess whether the user has manually locked the electronic device.

In another situation it may be undesirable to have the capability to unlock a secured device when the power is off. In an alternate embodiment, the switching and locking mechanisms may remain in a locked position while power is off. Further, there can be the capability to position the shutter member such that a user cannot remove the cable without moving the shutter member. In this embodiment, the user will not be able to detach the electronic device when power is off.

This invention provides significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention, which is limited only by the following claims.

1. An anti-theft system for securing a portable electronic device in order to prevent theft of the device comprising:
an electronic device having a housing with an opening in the housing for insertion of a locking mechanism into the opening;
a shutter member within said electronic device, said shutter member positioned in said device such that said shutter is capable of reconfiguring the opening in the housing of said electronic device;
a cable device for securing said electronic device to an object such that said electronic device is not easily moveable; and
a locking mechanism attached to said cable for insertion into said electronic device through the opening in the housing of said electronic device for securing said electronic device.

2. The anti-theft system as described in claim 1 wherein said shutter member is capable of reconfiguring the opening by moving in a predetermined direction that enables the shutter member to cover at least a portion of the opening in the housing of said electronic device.

3. The anti-theft system as described in claim 2 wherein the opening in the housing of said electronic device has a vertical portion and a horizontal portion.

4. The anti-theft system as described in claim 3 wherein the portion of the opening covered by the shutter member is the horizontal portion.

5. The anti-theft system as described in claim 1 wherein said shutter member engages said cable device such that when said locking mechanism is inserted into said electronic device, said shutter member is positioned between said locking mechanism and the opening in said housing.

6. The anti-theft system as described in claim 1 wherein said locking mechanism further comprises a pair of bars attached to the end of said cable device.

7. The anti-theft system as described in claim 6 wherein at least on of said bars has the capability to rotate with respect to the other bar to form a cross-shape configuration at the locking mechanism.

8. The anti-theft system as described in claim 7 further comprising a mechanism to control the rotation of the bar as desired by the user.

9. The anti-theft system as in claim 6 wherein one of said bars of is in permanently fixed position.

10. The anti-theft system as described in claim 6 wherein said bars are configured such that their configuration matches the configuration of the opening in the electronic device in order to facilitate the extension of the bars through the opening in the housing in order to attach the cable to the housing.

11. The anti-theft system as described in claim 10 wherein said bars could be in a cross-shape configuration before extension into said housing.

12. The anti-theft system as described in claim 10 wherein said bars could be reconfigured into a cross-shaped configuration after extension into said housing.

13. The anti-theft system as described in claim 1 further comprising a switching mechanism for controlling the movement of said shutter member.

14. A method for securing a portable electronic device in order to prevent theft of the device comprising the steps of:
receiving a signal from a user to activate the anti-theft security process;
sending a verification request to the user;
receiving the verification information from the user;
determining whether the requesting user has the authority to activate the anti-theft security process by comparing specific user information with specific information of the electronic device; and
activating the security process when the determination is that the user does have authority to activate the anti-theft security process by sending a signal to a switching mechanism in the electronic device that will cause a shutter member positioned in the electronic device to move from a current position to a new position such that the shutter member will cover at least a portion of a security opening in the electronic housing and thereby alter the configuration of the security opening and cause the attaching and locking of a cable device, that is inserted into the security opening, to the electronic device.

15. (canceled)

16. (canceled)

17. The method as described in claim 14 wherein a signal sent to the locking mechanism would cause the switching mechanism to move the position of the shutter member such that the configuration of the opening switches between an open configuration and a closed configuration.

18. The method as described in claim 17 wherein a signal sent to the locking mechanism would cause the switching mechanism to move a shutter member connected to the switching mechanism between an open position in which the shutter member does not cover the opening and a closed position in which the shutter member covers at least a portion of the opening.

19. A method for unsecuring a presently secured portable electronic comprising the steps of:
receiving a signal from a user to activate the anti-theft security process;
sending a verification request to the user;
receiving the verification information from the user;
determining whether the requesting user has the authority to activate the anti-theft security process by comparing specific user information with specific information of the electronic device; and
activating the security process when the determination is that the user does have authority to activate the anti-theft security process sending a signal to a locking mechanism in the electronic device that will cause a shutter member covering at least a portion of a security opening in the electronic housing in the electronic device to move in a direction such that the opening is no longer covered by the shutter member.

20. (canceled)
